(19) United States
(12) Patent Application Publication
(10) Pub. No.: US 2005/0082219 A1
(43) Pub. Date: Apr. 21, 2005

(54) Unsupported fluorocarbon copolymer membrane and a method for making the same

(75) Inventors: John A. Simonetti, Thousand Oaks, CA (US); Scott Yaeger, LaPorte, IN (US)

Correspondence Address: OBLON, SPIVAK, MCCLELLAND, MAIER & NEUSTADT, P.C., 1940 DUKE STREET, ALEXANDRIA, VA, 22314, US

(73) Assignee: PTI ADVANCED FILTRATION INC., Oxnard, CA (US)

(21) Appl. No.: 10/685,975

(22) Filed: Oct. 15, 2003

(51) Int. Cl. B29C 71/00

(52) U.S. Cl. 210/500.36; 264/494; 264/346; 210/500.42

(57) ABSTRACT

An unsupported fluorocarbon copolymer membrane is made unsupported by using a combination of two distinctly different processes: the first is an annealing heat treatment, and the second is a polymerization process using ultra-violet (UV) light and acrylate monomers (UV/Acrylic process) that may also make the membrane hydrophilic.

### RELATED APPLICATIONS

The instant patent application is related to U.S. Pat. No. 6,451,386 B1, the disclosure of which is hereby incorporated by reference in its entirety.

### FIELD OF THE INVENTION

The present invention is directed to porous filtration media and a method for manufacturing porous filtration media.

### BACKGROUND

Porous fluorocarbon (FC) membranes are widely used in applications requiring fine filtration and/or filtration of chemically reactive solutions. In many applications, porous FC membranes are formed into pleated filter elements that are packed between guards and end caps to form cartridge-type filters.

Traditionally, these membranes have been produced through casting processes involving support media. U.S. Pat. No. 5,988,400 to Karachevtcev et al. (issued Nov. 23, 1999) summarizes several “wet” (i.e., involving submersion in a liquid setting bath) and “dry” (i.e., involving evaporation of a liquid component(s) from a casting solution) casting processes. A common casting solution of tetrafluoroethylene (TFE)/vinylidene fluoride (VF) may be used. Additives such as polyvinylidene fluoride, vinylidene fluoride/trichloroethylene (TCE) copolymer and hexafluoropropylene/vinylidene fluoride may also be included in the casting solution to impart improved performance characteristics to the resulting membrane.

In the dry casting process described in the Karachevtcev et al. patent, the casting solution is prepared by dissolving the fluorocarbon copolymer in an organic readily-boiling solvent and mixing the resulting solution with a precipitating mixture (e.g., an alcohol/water mixture). The casting solution is then applied to a support. According to one embodiment of the Karachevtcev et al. patent, the support is made of a porous material, such as nonwoven polypropylene or porous polyethylene terephthalate. In other systems and methods described in the Karachevtcev et al. patent, the support is generally a dense (i.e., nonporous) material such as glass, stainless steel, polyethylene terephtalate film, or the like. The liquid components of the casting solution are then allowed to evaporate in a drying chamber. Drying may be done in stages and may involve passing air at specified temperatures and humidity contents over the applied casting solution. The drying process yields a porous fluorocarbon membrane sheet which may be cut and pleated to form filter elements for placement into cartridge-type filters.

The use of a porous or nonporous support adds significant cost to the resulting filter membrane. However, if the polymer membrane described in the Karachtcev et al. reference is cast unsupported or cast on a nonporous support that is later removed, and the membrane is dried at a temperature between 90° C. and 100° C. on a glass surface, the resulting membrane will shrink when later exposed to temperatures exceeding 100° C. Such membranes are unsuitable, for example, for pharmaceutical or other applications that require the membrane to be sterilized in an autoclave or for applications in which the medium to be filtered is heated above 100° C.

Porous polymeric materials are often used in filtration for filtering gases and liquids. In many applications of filtration technology, it is desirable to utilize a membrane filter, which is mechanically strong, is thermally stable, is relatively inert chemically and is insoluble in most organic solvents. Often, it is desirable that the membrane have surface properties that are radically different from the properties inherent in the polymeric material. Desirable surface properties include wetability and sufficient flow properties.

Porous polymeric materials can be modified by coating with, or grafting to, another polymer which possesses more desirable properties than the first. These types of modifications are often referred to as “surface modifications” or “surface coatings,” and are used to add properties to the bulk material that it does not otherwise possess.

Acrylate monomers have been widely used in polymerization reactions on the surface and in the matrices of porous polymeric “substrates” to impart desirable qualities to otherwise less useful filter materials. One example of such a desirable quality is to treat a hydrophobic filter material to render it hydrophilic. Hydrophobic (water-fearing) filter materials will not wet with water, whereas hydrophilic (water-loving) filter materials will. “Wetability” is a desirable quality since a majority of filtration applications encounter aqueous based solutions.

One possible way to impart desirable filter characteristics (such as hydrophilicity) to a porous polymeric structure is to cause the chains in the substance to cross-react with hydrophilic acrylate monomers. Acrylate monomers react with one another based on a “free radical” addition reaction mechanism and traditionally require a reaction initiator to start the chain growth process. These initiators are also referred to as free-radical initiators and are activated using some form of radiant energy.

U.S. Pat. No. 4,618,533 to Steuck discloses the use of acrylate monomers and “thermal” initiators to modify a polymeric membrane material. This patent requires the use of a free radical initiator and lists several compounds that may be employed as such, including persulfate, azo, and organic peroxy compounds. The initiator is traditionally considered a critical component because it forms free radicals when energy is added to the system in the form of heat, ultraviolet light, gamma or electron beam radiation to initiate the polymer chain growth process. Different initiators are specific for the type of energy sources used.

U.S. Pat. No. 4,886,836 to Gsell disclosed methods for “activation” of membrane surfaces. Gsell suggests gamma radiation is preferred as an energy source for activation of a membrane surface, probably because of the high energy level of gamma radiation. Gamma radiation provides such high energy that free radical initiators are not required. In using gamma radiation, free radicals are created everywhere, even in the monomers present. The phenomenon, in which the monomers are attached only to other monomers, is referred to as “homopolymerization.” A gamma source, however, is very expensive and requires safety controls, and may not be economically feasible to many. Electron beams may also be used as a radiation source, but the equipment to generate such energy is also very expensive.

U.S. Pat. No. 5,468,390 to Crivello, Belfort, and Yamagishi disclosed treating polyarylsulfone with acrylates and UV light to reduce the protein binding characteristics of this polymer. “Sensitizers,” free radical initiators, are not required because the polymer actually degrades to form free radicals and initiates the polymerization process. The mechanism of cleaving the polysulfone polymer chain is discussed in detail in this patent. The acrylic polymer is bound to the polysulfone membrane substrate by irradiating the sample for 3-5 minutes. Crivello et al. describe using a Southern New England Rayonette Irradiator equipped with sixteen low pressure mercury arc lamps with a broad emission at approximately 251 nm. In this example, the exposure time was relatively lengthy, at 5 minutes. Another experiment used a 450 Watt medium pressure Hanovia Inc mercury arc lamp for 3 minutes. Crivello et al. do not cover other polymer substrates; only polysulfone and polyethersulfone.

What is needed is a fluorocarbon copolymer membrane made unsupported to eliminate the need for a porous support material that may introduce unnecessary cost and compatibility constraints. It is desirable to utilize an unsupported fluorocarbon copolymer membrane which is mechanically strong, is thermally stable, is relatively inert chemically and is insoluble in most organic solvents. It is also desirable that the membrane have surface properties that are radically different from the properties inherent in the polymeric material. Such surface properties include wetability and sufficient flow properties. In addition, an unsupported fluorocarbon copolymer membrane must not shrink when later exposed to temperatures exceeding 100° C. Therefore, such membranes must be suitable, for example, for pharmaceutical or other applications that require the membrane to be sterilized in an autoclave or for applications in which the medium to be filtered is heated above 100° C.

### BRIEF DESCRIPTION OF THE DRAWINGS

FIG. 1 is a graph depicting the effect of the annealing treatment temperature on the peak tensile strength of a filter membrane;

FIG. 2 is a graph depicting the effect of the annealing treatment temperature on an elongation of the filter membrane;

FIG. 3 is a graph depicting the effect of the annealing treatment temperature on the bubble point pressure of the filter membrane;

FIG. 4 is a graph showing the effect of ten autoclave cycles on the flow rate for an annealed unsupported fluorocarbon copolymer membrane;

FIG. 5 is a graph plotting the percentage of shrinkage against autoclave cycles for annealed unsupported fluorocarbon copolymer membranes;

FIG. 6 is a process diagram showing a method for treating a continuous web with acrylate monomers and UV light;

FIG. 7 is a graph plotting the percentage of original flow rates against autoclave cycles for annealed and untreated fluorocarbon copolymer membranes;

FIG. 8 is a graph showing the effect of autoclave cycles on membrane shrinkage for annealed unsupported fluorocarbon copolymer membranes and annealed plus UV/Acrylic treated unsupported fluorocarbon copolymer membranes;

FIG. 9 illustrates a method for forming an annealed hydrophilic unsupported fluorocarbon copolymer membrane that has been treated with a UV/Acrylic process according to an embodiment of the present invention;

FIG. 10 illustrates a cartridge filter including a pleated membrane according to an embodiment of the present invention;

FIG. 11 illustrates a cartridge filter including membrane sheets according to an alternative embodiment of the present invention;

FIG. 12 illustrates a cartridge filter including membrane disks according to an alternative embodiment of the present invention; and

FIG. 13 illustrates a disc module according to an embodiment of the present invention.

### DETAILED DESCRIPTION

Embodiments of the present invention are directed to an unsupported fluorocarbon copolymer membrane and a method of making the same. The ability to make the membrane unsupported is based upon the use of a combination of two distinctly different processes: the first is an annealing heat treatment, and the second is a polymerization process using ultra-violet (UV) light and acrylate monomers (UV/Acrylic process) that will also make the membrane hydrophilic.

In the process of making membranes according to the present invention, the membrane may be annealed and UV/Acrylic process treated to substantially reduce the amount of membrane shrinkage that may result from subsequent heat treatments and to increase the membrane tensile strength. These unsupported fluorocarbon membranes may be less expensive to produce than their supported counterparts, since support material adds significant material cost to membrane sheets. Moreover, unsupported fluorocarbon membranes may by compatible with a broader range of chemical environments than supported membranes, since the chemical from which a support is formed may be incompatible with particular fluids being filtered. For example, polyester and polypropylene are known support materials for supported membranes. Polyester is sensitive to hydrolysis under extreme pH conditions whereas an unsupported fluorocarbon copolymer membrane is less sensitive. Polypropylene when used as a support may include polyethylene as a binding agent for binding the fibers together. Polyethylene has a lower molecular weight, has limitations to higher temperatures, and produces extractables that may cause contamination of fluid streams being filtered. In contrast, filters according to embodiments of the present invention may exhibit increased tensile strength, narrower pore size distribution and resistance to shrinkage when exposed to elevated temperatures in comparison to other unsupported membranes. As a result, these membranes may be used in applications that require autoclaving for sterilization.

According to the process of the present invention, a porous fluorocarbon membrane is produced by the “dry” method, which in accordance with the invention includes: dissolving of a copolymer in an organic readily-boiling solvent; mixing of the resultant copolymer solution with a precipitating mixture to form a casting solution; and forming the resulting casting solution into a membrane on a dense non-porous material, i.e. a support.

A fluorocarbon copolymer solution may be cast on a dense nonporous surface such as glass, plexiglass, or a dense film such as Mylar (polyester), polypropylene, polyethylene, polyvinylidine chloride (PVDC) or any suitable nonporous polymer film that will facilitate the casting and subsequent release of the cast membrane. The copolymer casting solution may include a dissolved fluorocarbon polymer (e.g., tetrafluoroethylene/vinylidene fluoride (TFE/VF) copolymer), a non-solvent (e.g., water or isopropyl alcohol (IPA)) and a solvent, such as acetone. A preferred solution includes (by weight) 9.5-12.5% polymer, 25-27% water/IPA and 60-64% acetone.

For casting an unsupported fluorocarbon membrane, the composition of the casting solution may include a larger percentage by weight of polymer and non-solvent and a smaller percentage by weight of solvent than is preferably used in the casting solution for a supported fluorocarbon membrane (described as 8-11% polymer, 21.8-23.3% water/IPA, and 66-69% acetone in the Karatchevtcev et al. patent). A casting solution of 23-25 weight percent tetrafluoroethylene (TFE) and 75-77 weight percent vinylidene fluoride (VF) may be used. Additives such as polyvinylidene fluoride, vinylidene fluoride/trichloroethylene (TCE) copolymer and hexafluoropropylene/vinylidene fluoride may also be included in the casting solution to impart improved performance characteristics to the resulting membrane.

The membrane is formed by deposition on the non-porous support with the heated casting solution of copolymer, consisting of 23-25% by weight tetrafluoroethylene and 75-77% by weight vinylidene fluoride and having a ratio of viscosity of solution in acetone to acetone equal to 2-4, with copolymer content in the solution in the amount of 0.01 g/cm³. This is followed by a short-term storage of the membrane being formed under such conditions as to promote the free evaporation of a portion of solvent for partial hardening of the casting solution, and then subsequent drying of the resulting membrane, for example, in three successive drying zones, wherein temperature is maintained such that it increases from one zone to another.

In accordance with the “dry” process, ketones, e.g. methyl ketone and acetone, are preferably used as the readily-boiling organic solvent for the fluorocarbon polymer (mixture of fluorocarbon polymers). When using acetone, which is a preferred embodiment, it is taken in the amount of 60-70% by weight of the weight of casting solution, wherein the concentration of fluorocarbon polymer itself is from 7 to 12% by weight.

Also, in accordance with the “dry” process, an alcohol/water mixture is used as a precipitating mixture. Ethanol, butanol, propanol and isopropanol may also be used. However, isopropanol or propanol are preferably used in an amount of at least 14% by weight, practically from 14 to 17% by weight, based on the casting solution weight. Deionized water is used as water in the amount of at least 5.0% by weight, practically from 5 to 10% by weight, based on the casting solution weight. Water is preferably deionized to the point where metal and salt content is less than 2.0 g/m³.

According to embodiments the present invention, dissolving of the fluorocarbon polymer, in particular, the tetrafluoroethylene/vinylidene fluoride copolymer, is performed at an elevated temperature, preferably at 30° C.-50° C.

According to embodiments the present invention, the precipitating mixture is produced separately from the fluorocarbon polymer solution by mixing deionized water and alcohol at a temperature ranging from 18° C. to 25° C., under the pressure of inert gas, preferably nitrogen, ranging from 2 Pa to 2 kPa.

According to embodiments the present invention, further mixing of the fluorocarbon polymer solution and the precipitating mixture is performed at an elevated temperature, preferably at 45° C.±5° C. When the precipitating mixture is fed into a reactor containing the heated fluorocarbon polymer solution, in accordance with the invention, the temperature difference between the fluorocarbon polymer solution and the precipitating mixture should not exceed about 3° C. Failure to observe this condition may make processing of the resulting casting solution into a high-quality membrane more complicated.

The casting solution may be deposited on the dense surface using any of a number of deposition processes, since, unlike processes for manufacturing supported fluorocarbon membranes, it is not essential that the casting solution be absorbed. Possible deposition processes for use in making membranes according to embodiments of the present invention include vapor phase deposition (e.g., vacuum evaporation, sublimation, and chemical vapor deposition), and solution or dispersion coating (e.g., dip coating, spray coating, spin coating, blade or knife coating, bar coating, roll coating, and pour coating). Knife coating has been found to be both effective and economical. The particular thickness of the casting solution layer varies depending upon the application for which the membrane is to be used. For example, a casted membrane layer may be approximately 100-200 microns thick.

After the application of the casting solution onto the non-porous support is complete, the support and the casted membrane are subjected to a short-term storage under such conditions as to promote the free evaporation of a portion of the solvent at 18° C.-25° C. for approximately 0.5-1.0 minutes. Under these conditions, partial hardening of the casting solution occurs and a porous membrane starts to form.

The membrane formation process continues with the drying stage, which in accordance with a preferred embodiment of the present invention, is carried out in three or more successive drying zones. Various temperatures are maintained in the zones, which temperatures increase as the resulting membrane is transferred from zone to zone, absolute humidity in the zones is maintained at approximately a similar level. Preferred temperature values in the drying zones are as follows:
first zone—from 45° C. to 55° C.
second zone—from 55° C. to 65° C.
third zone—from 90° C. to 100° C.

The casting solution deposited and dried on the dense non-porous surface may be further heated (annealed) to temperatures up to the polymer membrane glass transition temperature T_{g} (when a polymer transitions from a glassy state to a liquid state, for example, at approximately 125° C. to 150° C.) in a subsequent annealing process. The cast membrane may then be released or separated from the dense surface.

The resulting unsupported fluorocarbon copolymer membrane may be described as being formed from a tetrafluoroethylene and polyvinylidene difluoride copolymer heated in solution, dried, and then annealed at an elevated temperature to cause physical changes to take place in the copolymer structure to cause a crystallization or ordering of the polymer chains. The resulting membrane may generally have a narrower pore size distribution as evidenced by a higher flow rate, increased tensile strength and relatively unchanged elongation when compared with unsupported fluorocarbon membranes of the composition described in the Karatchevtcev et al. patent. The unsupported fluorocarbon copolymer membrane has yet to be treated with the UV/Acrylic process and thus is hydrophobic.

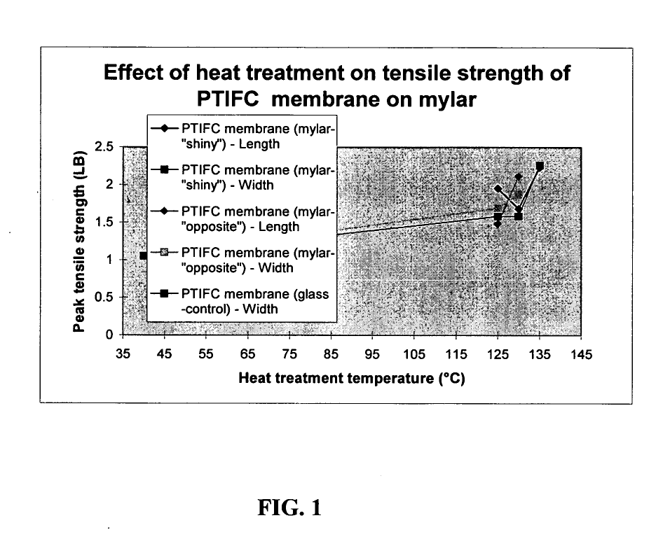

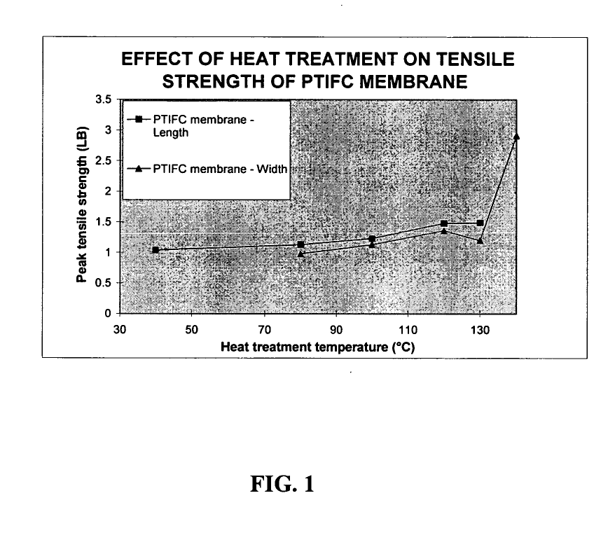

FIG. 1 illustrates the effects of the annealing temperature on the peak tensile strength of membranes made according to a particular embodiment of the present invention. The tensile strengths in the lengthwise and widthwise directions are shown by separate lines. The PTI fluorocarbon (PTIFC) membrane is cast on either a mylar or a glass dense surface. The tensile strength is plotted along the y-axis of the chart, while the annealing temperature is plotted along the x-axis. As indicated by testing, the tensile strength of the membrane according to an embodiment of the present invention rises sharply (from approximately 1.0 lb. to approximately 2.5 lb.) as the annealing temperature is raised from 130° C. to 140° C.

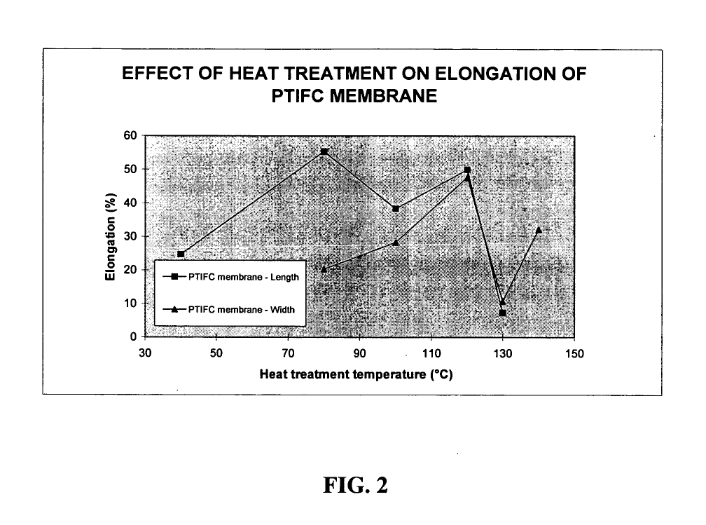

FIG. 2 illustrates the relationship (or lack thereof) between the annealing temperature and the elongation of the membrane. Elongation is a measure of how far the membrane stretches before breakage occurs, and is measured by percentage of increase in the direction being stretched at break. As indicated, no clear trend is shown between the elongation of the membrane material and the temperature at which it is annealed. Extensive testing at various annealing temperatures indicates that the elongation of the membrane is not compromised as a result of the heat-annealing step.

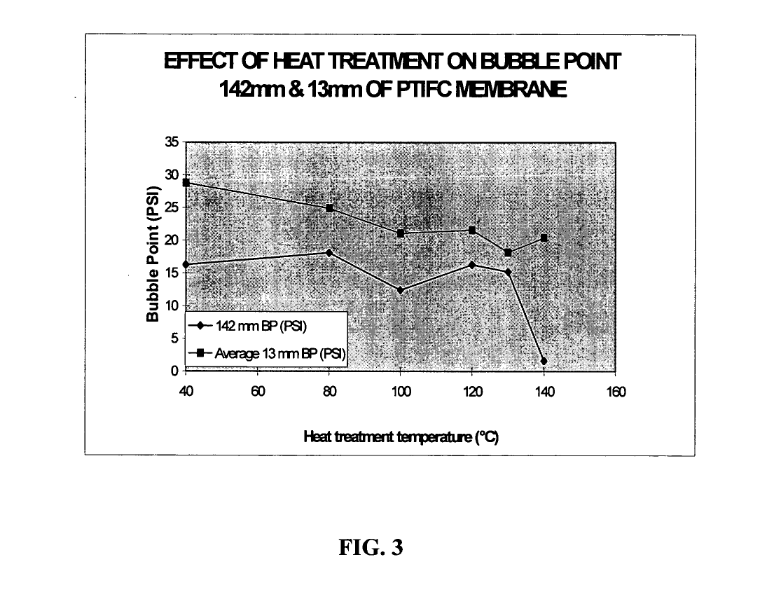

FIG. 3 illustrates the relationship between the bubble point pressure of the annealed membrane produced according to a process embodiment of the invention. The bubble point test is a measurement of the largest pore size of the membrane and is indicative of the expected filtration properties of the membrane. The bubble point test consists of filling the membrane with water, then measuring the amount of air pressure required to blow water out of the pore. For example, a pressure of 15 psi. was measured for a 142 mm disk of membrane material for annealing temperatures of 130° C. Two lines, reflecting the bubble points measured for a 13 mm disk of membrane material and a 142 mm disk of membrane material annealed at various temperatures, are shown. The graph for the 142 mm disk sample indicates that the bubble point of the membrane is largely unaffected by the annealing temperature until the annealing temperature exceeds 130° C. The graph corresponding to the 142 mm disk also indicates that the membrane may not withstand an annealing temperature of 140° C.

Based on the results of the bubble point test, the tensile strength test, and the elongation test, an annealing temperature in the range of about 130° C. and 140° C. is believed to yield a membrane of superior properties.

It will be readily understood that while the tensile strength, elongation and bubble points for one embodiment of the present invention are shown in FIGS. 1-3, the actual properties of other embodiments of the invention may depend upon the precise chemical composition of the membrane material. Furthermore, although the properties of the tested embodiment are shown in the form of straight-line fitting between measured values, it will be appreciated that the actual properties of the tested embodiment of the present invention may more accurately be estimated through curve fitting between the measured points. However, it is believed that FIGS. 1-3 accurately depict the general relationship between the measured properties and annealing temperature for membranes of various compositions made according to embodiments of the present invention.

As shown in the chart in FIG. 1, the peak tensile strength of the particular embodiment of the unsupported fluorocarbon membrane is largely unaffected by the annealing step until the annealing temperature is raised above 130° C. However, as shown in FIG. 3, the membrane may not be able to withstand annealing temperatures approaching or above 140° C. Accordingly, in a preferred embodiment of the invention, the annealing temperature may be limited to a range between 130° C. and 140° C. The optimal annealing range may vary according to the composition of the casting solution and the type of dense surface upon which the membrane is cast.

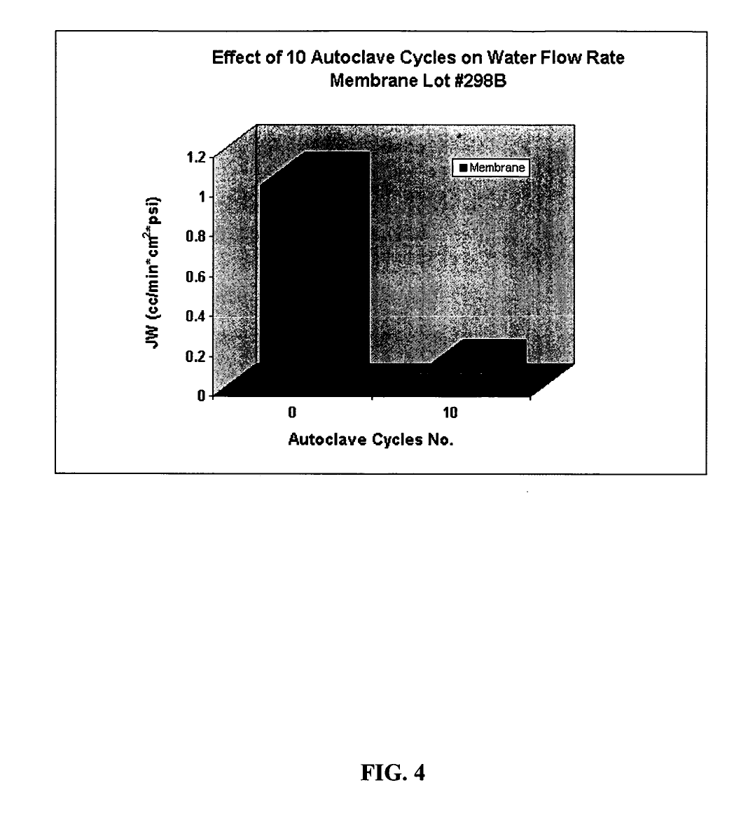

In some instances, the resulting annealed unsupported fluorocarbon copolymer membrane may still experience shrinkage and a loss in water flow rate when subjected to autoclaving. FIG. 4 illustrates an unfavorable relationship between exposure to ten 130° C. autoclave cycles and membrane shrinkage.

Membrane samples were exposed to multiple autoclave cycles at 130°. The samples were previously annealed at 130° C. on glass plates. An annealed hydrophobic membrane that has been subjected to 10 successive autoclave cycles is compared with an annealed hydrophobic membrane not subjected to autoclaving. The data in FIG. 4 shows that the water flow rate dropped from 1.06 to 0.12 cc/min-psi-cm² for a sample tested in the 13° C. autoclave for 10 cycles. The observed loss in water flow rate is supported by the observation that the membrane shrinks in the autoclave.

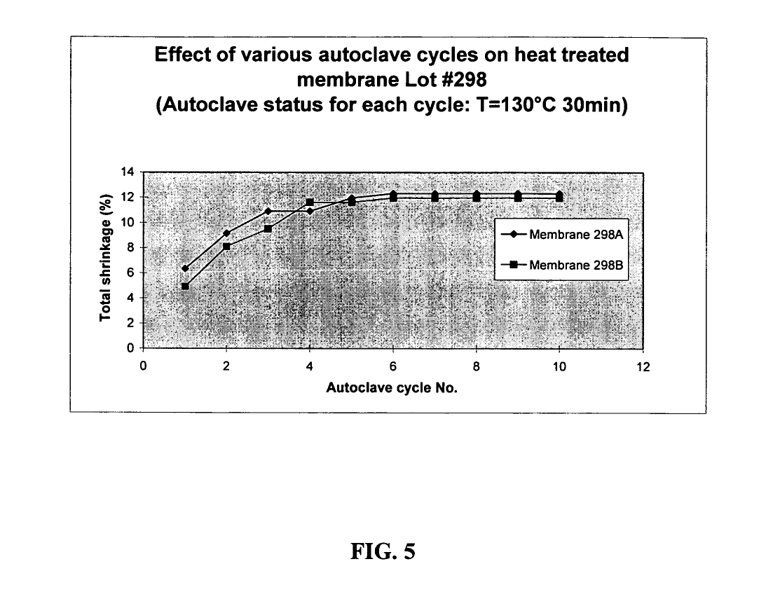

Furthermore, the graph depicted in FIG. 5 also supports the evidence that multiple autoclaving at 130° C. results in membrane shrinkage and explains the resulting flow loss. The graph indicates that the samples heat treated at 130° C. showed increased shrinkage with increasing number of auto claves.

To counteract these problems, the annealed unsupported fluorocarbon copolymer membrane may be further treated with ultra-violet radiation in the presence of acrylate monomers. A process for treating membranes with acrylate monomers is described in U. S. Pat. No. 6,451,386 B1.

According to one embodiment of the invention, the unsupported fluorocarbon copolymer membrane is exposed for a period of time to ultraviolet (UV) light in the presence of hydrophilic monomers such as hydroxypropyl acrylate (HPA) and tetraethylene glycol diacrylate (TEGDA) in solution. The growing polymer chain becomes an integral part of the porous polymeric material causing a change from the native hydrophobic state to a modified hydrophilic water-wetting state. Other acrylate monomers besides hydroxypropyl acrylate (BPA) and tetraethylene glycol diacrylate (TEGDA) may be used in this process. For example, trimethylolpropane triacrylate (TMPTA) may be used as a monomer in this process.

The period of irradiation time may range from about 0.1 to 1 seconds. An ultraviolet lamp used according to the present invention has a UV light that is focused, through use of a parabolic or elliptical reflector. The focused UV light has increased intensity (Watts/cm²) and dosage (Joules/cm²) at the focal point.

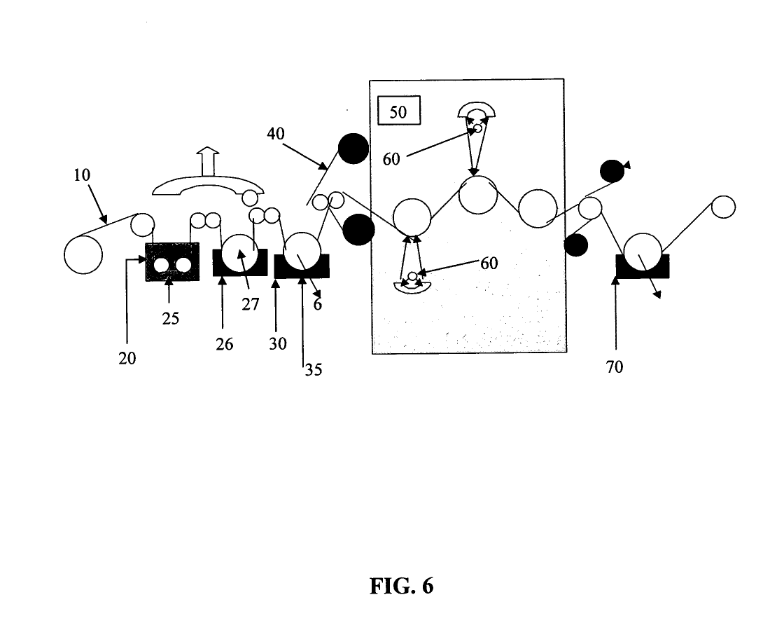

A process for treating an unsupported fluorocarbon copolymer membrane (referred to simply as a membrane web) is depicted in FIG. 6. A system and method for flushing a membrane web using a vacuum roller is described in U.S. Pat. No. 6,634,192, the disclosure of which is hereby incorporated by reference in its entirety. This process involves the use of a porous roller over which the membrane web travels. The driven roller is connected to a vacuum source and holds the membrane web tightly as it travels over the rotating roller, also described as a vacuum roller. The web may travel on one or more vacuum rollers which are partially submerged in the solutions of choice to apply the desired chemical. For example, the roller is dipped into a bath containing a second solvent that is to be exchanged with a first solvent existing in the membrane. Since the membrane contains very small pores, there is no flow of air through the membrane when in contact with the vacuum roller due to capillary forces holding liquid in the pores. As the membrane is submerged in the liquid, however, water flows freely through the membrane. The vacuum is the driving force and the trans-membrane differential pressure at 28″ Hg is approximately equal to 14 psig. This is approximately 82 times the pressure achieved by conventional water bearing tubes. Using the same speed and amount of wrap, one vacuum roller can accomplish what 82 water bearing tubes can. The volume of liquid flushed through a typical 0.1 μm membrane in one pass at 5 ft/minute is as follows:
Volume flushed/cm²=Flow rate×minutes×psi
Volume=0.25 cm³/min-psi-cm²×(4.7/60 minutes)×14 psi
Volume=0.274 cm³/cm²

The use of vacuum rollers allows faster flushing than conventional methods, better process control, and a smaller volume of chemicals. The use of vacuum rollers in the process of modifying porous membranes is described in detail below.

The monomer solutions in the examples described below do not wet all types of membranes spontaneously. Therefore, in some cases, a first bath 20 containing alcohol solution 25 having a sufficiently low surface tension is used to readily wet the membrane 10 (see FIG. 6). However, the monomer solution 35 could conceivably have a sufficiently low surface tension to wet the membrane 10 and eliminate the need for a “wetting bath” 20 and a “rinse bath” 26, as long as the components in the monomer-containing-liquid 35 do not adversely affect the polymerization process.

Assuming an alcohol solution 25 is used to wet the membrane 10, the membrane web 10 travels through a wetting bath 20 containing an alcohol 25 capable of wetting the membrane 10. Several solutions have been successfully used for this wetting bath such as methanol, ethanol and isopropyl alcohol. These solutions work equally well when diluted in water up to approximately 50% by volume.

The membrane web 10 then travels into a second bath 26 containing water. The purpose of this bath is to rinse out the alcohol. The inventors have discovered that alcohols have a negative effect on the polymerization process. That is, the treatment is imperfect or may not be permanent if alcohols are present. The water is preferably applied using a porous vacuum roller 27 over which the membrane 10 travels. This enables extremely efficient flushing in a short period of time. The membrane 10 then travels into a third bath 30 containing an aqueous solution of the monomers 35.

This procedure is not limited to “aqueous solutions” or even “solutions” for that matter. The application of the monomers may also work with suspensions, and need not be aqueous based. The preferred method is to flush the monomer solution 35 through the membrane 10 using vacuum. This allows the membrane 10 to be flushed without diluting the monomer solution 35.

The monomer solution 35 is preferably applied using a porous vacuum roller 6 over which the membrane 10 travels. Using the example of a porous vacuum roller, the amount of liquid 35 flushed through the membrane 10 is dependent on the membrane web 10 speed, the amount of vacuum applied, the contact time and the liquid flow rate through the membrane 10. The vacuum roller may be made from any suitable material that is compatible with the solution 35 used, examples include polypropylene or sintered stainless steel.

Following the application of the monomer solution 35, the membrane web 10 is then sandwiched between two layers of dense polyethylene film 40 and carried into a chamber 50 containing at least one UV light source 60. An illustrative thickness for film 40 is 200 μm. The purpose of the dense polyethylene film 40 is to keep oxygen away from the membrane web 10.

Another way to eliminate oxygen from the reaction is to purge the UV light chamber 50 with nitrogen or another inert gas. Because oxygen interferes with the polymerization process, it must be eliminated or at least minimized both in the chamber 50 and in the monomer solution 35 as well. This may be accomplished by bubbling nitrogen gas through the monomer solution 35.

A preferred laboratory UV light source is a Fusion UV System Model F300S-6 employing “D,” “H” or “V” bulbs with a width of 6 inches. Larger production systems are available that contain wider bulbs that can be positioned to span across a wider membrane web. These systems strategically place 10 inch bulbs to optimize the resulting UV light output and web coverage. Bulbs with different wattage outputs are also available and may be used with varying results. For production purposes, Model F450T-40 60 is suitable to irradiate a 40″ membrane web on both surfaces.

The membrane web 10 containing monomer solution 35 is exposed to the UV light source 60 at a focal point for about 0.5 seconds on each side. The polyethylene film 40 is removed from both sides of the web 10, and the membrane web 10 is then washed with deionized water 70, followed by drying. Here also, a vacuum roller works best.

After exposure of fluorocarbon copolymer membrane samples with HPA, TEGDA, and UV light, the membranes' physical properties were enhanced. Membrane samples were tested for physical dimensions and performance properties before and after autoclaving in a Brinkman 2540E table top autoclave at 125° C. The results indicate that UV/Acrylic modified membranes survive autoclave conditions better than unmodified membranes, as evidenced by less shrinkage and higher water flow rates. Membrane strength and temperature stability are important properties since membranes are often subjected to autoclave conditions during sterilization.

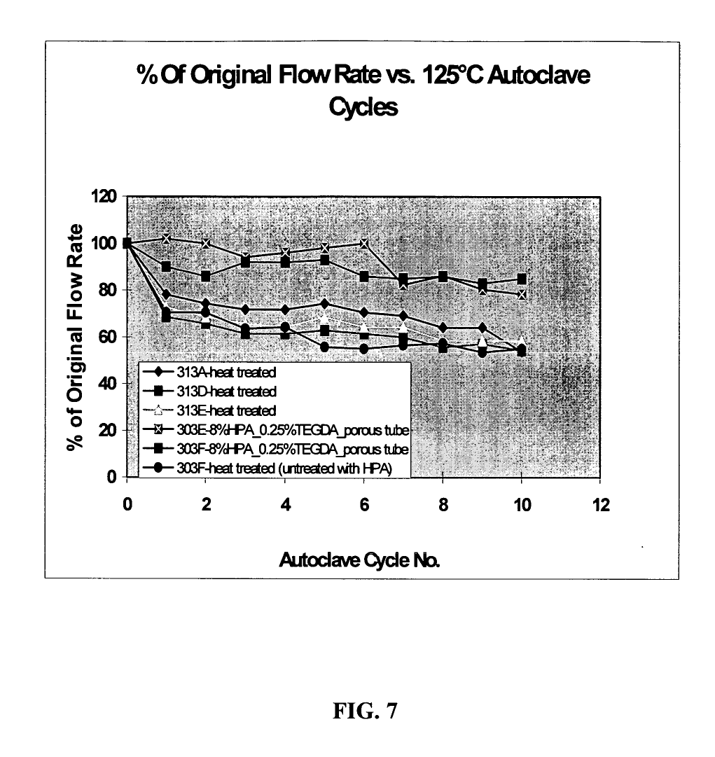

FIG. 7 shows that the samples which were modified with the UV/Acrylic process demonstrated less of a reduction in water flow rate. The results indicate that the water flow rate for untreated/unmodified (hydrophobic) membrane samples, that have only been annealed, decreases by about 30% after one cycle at 125° C. For the subsequent cycles, the water flow rate does not show as much of a decrease, but the damage has already been done.

There is, however, a marked difference in the membrane ability to withstand multiple autoclave cycles after UV/Acrylic hydrophilization treatment. The graph in FIG. 7 demonstrates that the membrane when first annealed and then treated with acrylate and ultraviolet is more robust and resistant to 125° C. autoclave conditions. The graph depicted in FIG. 7 shows a dramatic drop in water flow rate for the hydrophobic samples, while the two samples (303 F-8% HPA, 0.25% TEGDA) that were hydrophilized with the UV/Acrylic treatment showed only marginal water flow loss.

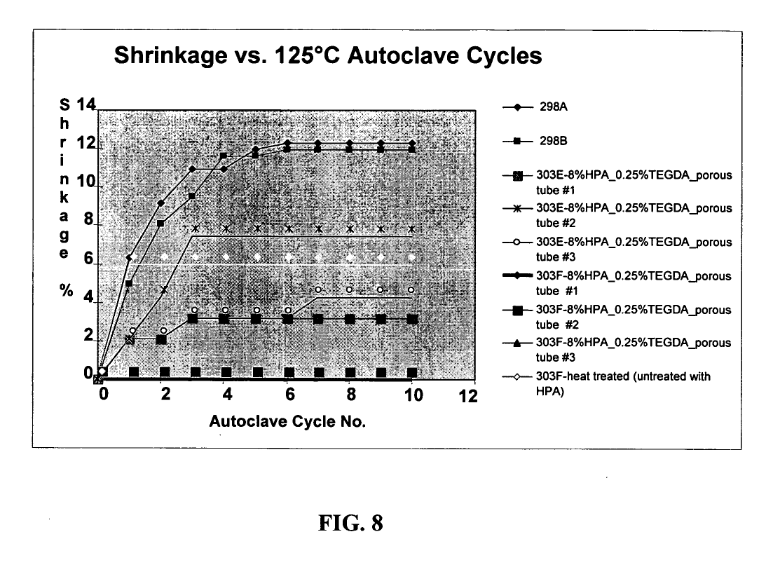

The observed water flow rate reduction of the unmodified membrane is a result of shrinkage, which is more pronounced on the unmodified samples. This is also evidenced by the minimal shrinkage of the UV/Acrylic treated samples as compared to the untreated (298A, 298B), depicted in FIG. 8. The UV/Acrylic treatment imparts desirable physical properties to the unsupported fluorocarbon copolymer membrane used in this example.

Another important observation made during this experiment is that two samples submerged in a water filled beaker withstood the autoclave conditions the best as compared to samples that were only wetted with water and sandwiched between polyester fabric layers. The two samples submerged in the water filled beaker show little or no shrinkage as shown in FIG. 8.

Resistance to autoclaving is an important property of this membrane due to fact that a large number of applications rely on sterilization of the membrane filters in an autoclave or in-line steam. The conclusion is that the hydrophilic membrane, as treated using the UV/Acrylic process, imparts strength and temperature resistance to the Fluoro-Copolymer (PVDT) membrane.

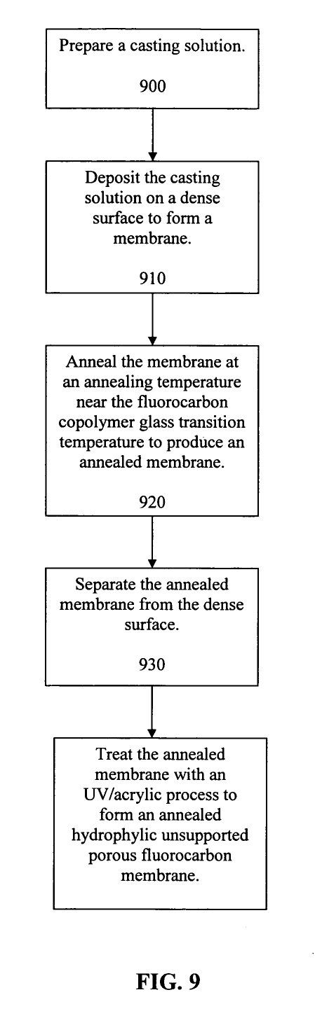

FIG. 9 illustrates a method for forming an annealed hydrophilic unsupported fluorocarbon copolymer membrane that has been treated with a UV/Acrylic process according to an embodiment of the present invention. A casting solution including a solvent, a non-solvent and a dissolved fluorocarbon copolymer is prepared 900. The casting solution is deposited 910 on a dense surface to form a membrane. The membrane is annealed 920 at an annealing temperature near the fluorocarbon copolymer glass transition temperature to produce an annealed membrane. The annealed membrane is separated 930 from the dense surface. The annealed membrane is treated 940 with an ultra-violet (UV)/acrylic process to form the annealed hydrophilic unsupported porous fluorocarbon membrane.

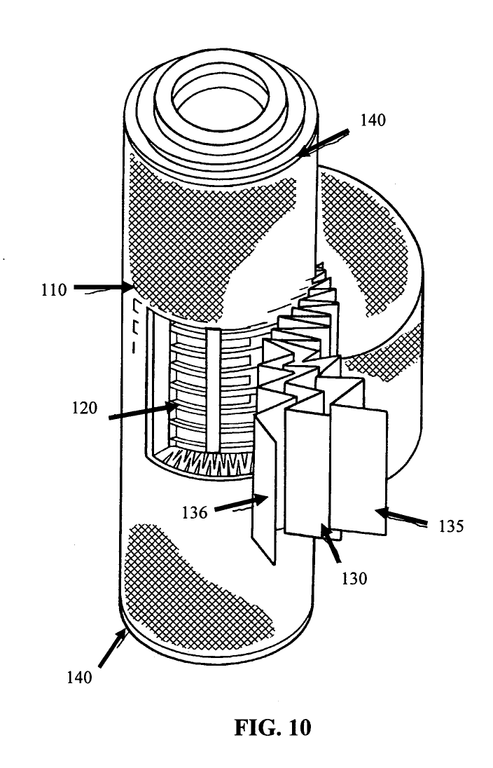

FIG. 10 illustrates a cartridge filter including a pleated membrane according to an embodiment of the present invention. The cartridge filter 100 consists of a protective guard 110, a supporting perforated hollow core 120, end caps 140, and a pleated annealed hydrophilic unsupported porous fluorocarbon membrane 130 equipped with a permeable support layer 135 and a permeable drainage layer 136. The pleated annealed hydrophilic unsupported porous fluorocarbon membrane 130 equipped with the permeable support layer 135 and the permeable drainage layer 136 is placed between the protective guard 110 and the supporting perforated hollow core 120, and integrally connected to the end caps 140, wherein at least one of the caps 140 is connected with the perforated hollow core 120. The pleated annealed hydrophilic unsupported porous fluorocarbon membrane 130 is formed from a tetrafluoroethylene and polyvinylidene difluoride copolymer heated in solution, dried, and then annealed at an elevated temperature to cause physical changes to take place in the copolymer structure to cause a crystallization or ordering of the polymer chains. The annealed unsupported fluorocarbon copolymer membrane is also treated with the UV/Acrylic process and thus is hydrophilic.

In order to improve performance of the cartridge filter, i.e. degree of cleaning, amount of impurities retained, reliability and durability, an alternative embodiment of the invention includes two pleated annealed hydrophilic unsupported porous fluorocarbon membranes 130 superimposed such that the membrane 130 which is closer to the permeable support layer 135 may have, for example, a pore size ranging from 0.2 to 0.8 microns, and the second membrane 135 may have, for example, a pore size in the range of 0.04-0.45 microns. Alternatively, the two membranes may have, for example, an equivalent pore size ranging 0.04-0.8 microns.

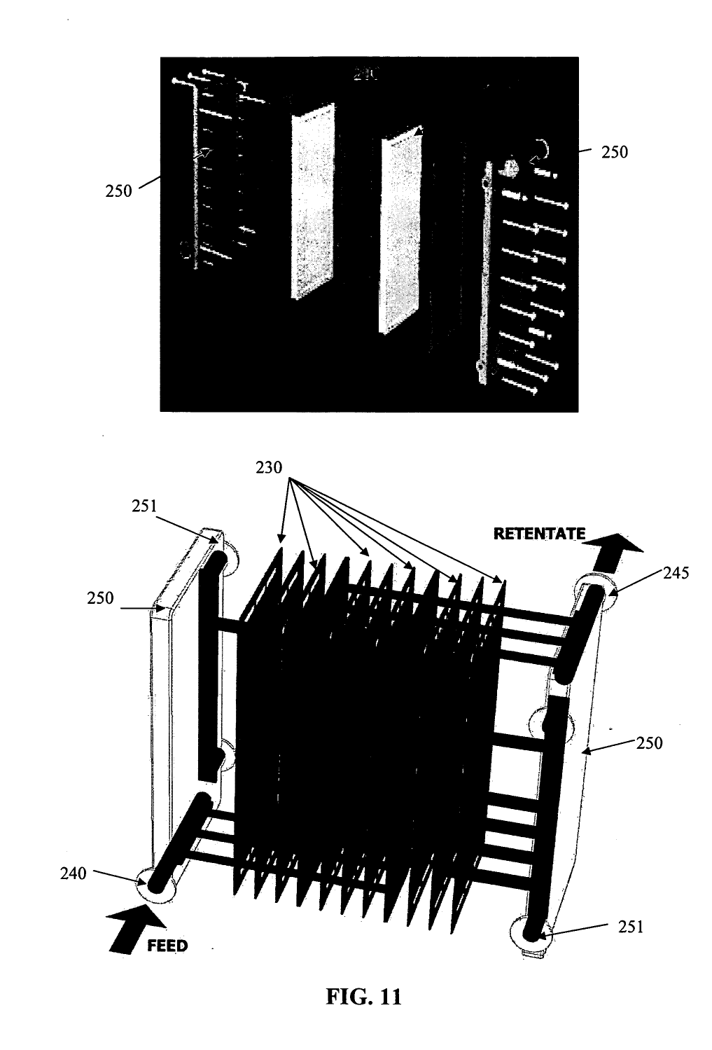

FIG. 11 illustrates a cartridge filter including membrane sheets according to an alternative embodiment of the present invention. The cartridge filter 200 includes annealed hydrophilic unsupported porous fluorocarbon membranes in the shape of flat sheets 230 contained in a housing 250. The feed enters an inlet 240 in the housing 250 and travels along the surface of the membrane in a cross-flow mode. The retentate exits an outlet 245 in the housing 250. The permeate flow is strategically directed from the downstream side of the membrane through a drainage layer to the permeate outlet 251. The cartridge filter 200 includes flat sheet membranes available in a range of pore sizes to accommodate ultra filtration, microfiltration, nanofiltration, and reverse osmosis processes.

The cartridge filter 200 is designed for processing solutions in the laboratory, pilot plant, and manufacturing suite. Hydrophilic membranes used in cross-flow modes minimize gel layer build-up and membrane fouling yielding a performance increase over traditional filters.

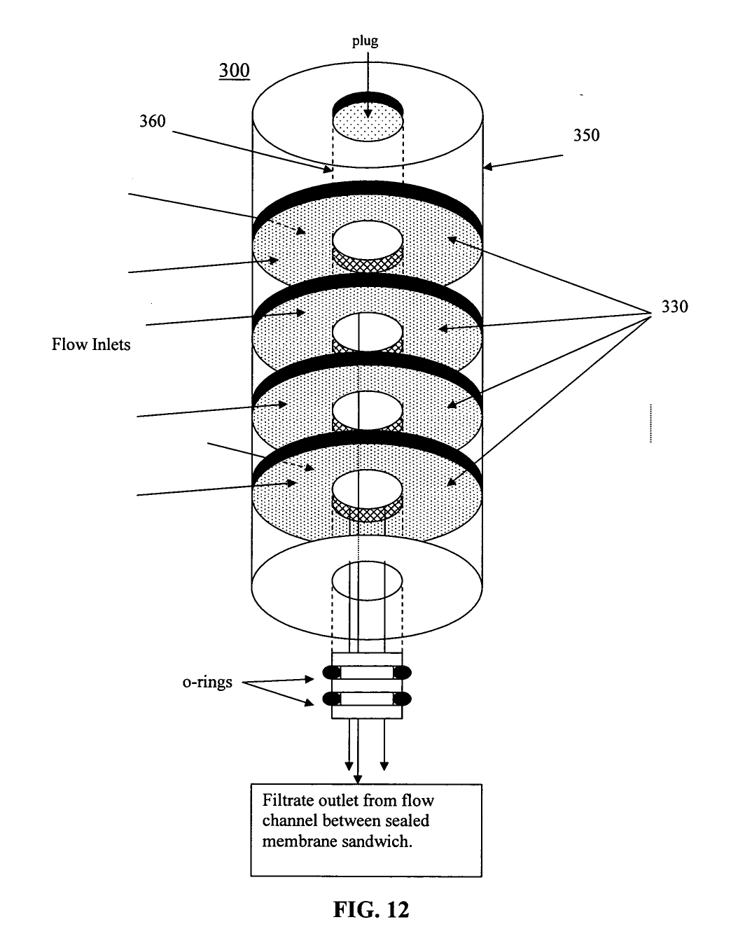

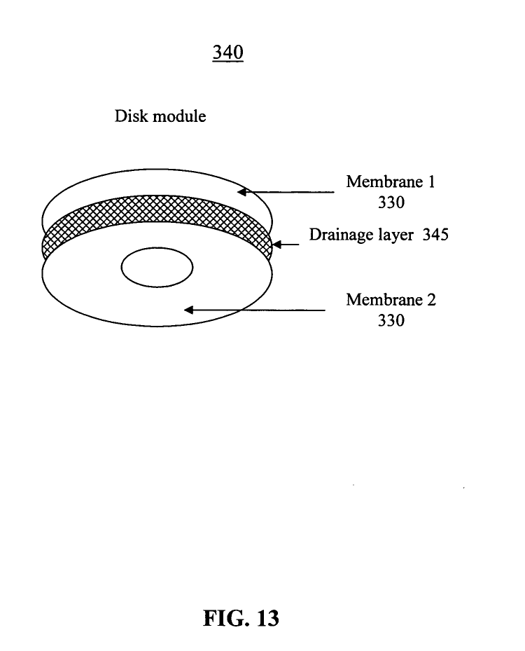

FIG. 12 illustrates a cartridge filter including membrane discs according to an alternative embodiment of the present invention. The cartridge filter 300 includes annealed hydrophilic unsupported porous fluorocarbon membranes in the shape of flat discs 330 laminated together to form a disk module 340. The disk modules 340 are stacked one on top of another and contained in a guard 350. FIG. 13 illustrates a disc module according to an embodiment of the present invention. Each disc module 340 contains two annealed hydrophilic unsupported porous fluorocarbon membrane discs 330 with a drainage layer 345 “sandwiched” in between. Each disk module 340 is sealed around the perimeter and to adjacent disk module 340. The filtrate is directed to a center outlet tube 360. The cartridge filter 300 uses laminated stacked disc membranes 330 designed for the removal of particles and microorganisms from liquids and gases. The stacked disc design allows minimal materials of construction, hold-up volume and particle shedding, making cartridge filter 300 ideally suited for high-value added applications. The cartridge filter 300 manufactured with annealed hydrophilic unsupported porous fluorocarbon membranes in the shape of flat discs 330, provides low extractables, broad chemical compatibility and low protein binding. Annealed hydrophilic unsupported porous fluorocarbon membrane discs 330 may include 0.1 μm, 0.2 μm (hydrophilic and hydrophobic), 0.45 μm and up to 5.0 μm pore sizes.

1. A method for making an unsupported porous fluorocarbon membrane, the method comprising:
preparing a casting solution including a solvent, a non-solvent and a dissolved fluorocarbon copolymer;
depositing the casting solution on a dense surface to form a membrane;
annealing the membrane at an annealing temperature near a fluorocarbon copolymer glass transition temperature to produce an annealed membrane;
separating the annealed membrane from said dense surface; and
treating the annealed membrane with an ultra-violet (UV)/acrylic process to form the unsupported porous fluorocarbon membrane.

2. The method according to claim 1, wherein said annealing temperature is within the range of about 130° C. to 140° C.

3. The method according to claim 1, wherein said dense surface is selected from the group consisting of glass, plexiglass, Mylar (polyester), polypropylene, polyethylene, and polyvinylidine chloride (PVDC).

4. The method according to claim 1, wherein depositing said casting solution includes coating a portion of said dense surface with said casting solution using a knife coating process.

5. The method according to claim 1, wherein said annealing temperature is selected to maximize a tensile strength of the annealed membrane.

6. The method according to claim 1, wherein said solvent is acetone.

7. The method according to claim 1, wherein said non-solvent is one of water and alcohol.

8. The method according to claim 1, wherein said casting solution includes, by weight, 9.5 to 12.5% of said fluorocarbon copolymer, 25 to 27% of said non-solvent and 60-64% of said solvent.

9. The method according to claim 1, wherein the UV/acrylic process includes:
applying a monomer solution to said annealed membrane; and
applying energy to said annealed membrane to initiate the creation of free radicals in said annealed membrane.

10. The method according to claim 9, wherein said monomer solution includes an acrylate monomer.

11. The method according to claim 9, wherein applying energy to said annealed membrane includes irradiating said annealed membrane with ultraviolet light.

12. The method according to claim 11, wherein an irradiated surface of said annealed membrane is not in contact with oxygen when said annealed membrane is irradiated with ultraviolet light.

13. The method according to claim 12, wherein said irradiated surface is placed in contact with an airtight film capable of transmitting said ultraviolet light.

14. The method according to claim 11, wherein irradiating said annealed membrane includes focusing energy from an ultraviolet energy source onto an irradiated surface of said annealed membrane.

15. A method for making an unsupported permeable membrane, the method comprising:
preparing a casting solution including a solvent, a non-solvent and a dissolved fluorocarbon copolymer;
depositing the casting solution on a dense surface to form a membrane;
annealing the membrane at an annealing temperature near a polymer glass transition temperature to produce an annealed membrane;
separating the annealed membrane from said dense surface;
applying a monomer solution to said annealed membrane; and
applying energy to said annealed membrane and said monomer solution to initiate creation of free radicals in said annealed membrane and free radicals in said monomer solution, wherein said annealed membrane and said monomer solution react in a polymerizaton process.

16. The method according to claim 15, wherein said annealing temperature is within the range of about 130° C. to 140° C.

17. The method according to claim 15, wherein said dense surface is selected from the group consisting of glass, plexiglass, Mylar (polyester), polypropylene, polyethylene, and polyvinylidine chloride (PVDC).

18. The method according to claim 15, wherein depositing said casting solution includes coating a portion of said dense surface with said casting solution using a knife coating process.

19. The method according to claim 15, wherein said annealing temperature is selected to maximize a tensile strength of said annealed membrane.

20. The method according to claim 15, wherein said solvent is acetone.

21. The method according to claim 15, wherein said non-solvent is one of water and alcohol.

22. The method according to claim 15, wherein said casting solution includes, by weight, 9.5 to 12.5% of said fluorocarbon copolymer, 25 to 27% of said non-solvent and 60-64% of said solvent.

23. The method according to claim 15, wherein said monomer solution includes an acrylate monomer.

24. The method according to claim 15, wherein applying energy to said annealed membrane includes irradiating said annealed membrane with ultraviolet light.

25. The method according to claim 24, wherein an irradiated surface of said annealed membrane is not in contact with oxygen when said annealed membrane is irradiated with ultraviolet light.

26. The method according to claim 25, wherein said irradiated surface is placed in contact with an airtight film capable of transmitting said ultraviolet light.

27. The method according to claim 24, wherein irradiating said annealed membrane includes focusing energy from an ultraviolet energy source onto an irradiated surface of said annealed membrane.

28. An annealed hydrophilic unsupported porous fluorocarbon membrane formed by:
dissolving a fluorocarbon polymer, including a tetrafluoroethylene/vinylidene fluoride copolymer, in a heated solvent, mixing a resultant copolymer solution with a precipitating mixture to produce a heated casting solution, the heated casting solution comprising a fluorocarbon polymer component including 23-25 weight percent tetrafluoroethylene and 75-77 weight percent vinylidene fluoride;
depositing said heated casting solution on a non-porous surface to form a deposited casting solution;
annealing the deposited casting solution at an annealing temperature near a polymer glass transition temperature to produce an annealed membrane;
separating the annealed membrane from said non-porous surface to form an annealed unsupported membrane; and
treating the annealed unsupported membrane with an ultra-violet (UV)/acrylic process to form an annealed hydrophilic unsupported porous fluorocarbon membrane.

29. The annealed hydrophilic unsupported porous fluorocarbon membrane of claim 28, wherein said membrane contains, as the fluorocarbon polymer, the mixture of polymers comprised of at least 85.0 weight percent tetrafluoroethylene/vinylidene fluoride copolymer and a fluorocarbon polymer selected from the group consisting of polyvinylidene fluoride, vinylidene fluoride/trifluorochloroethylene copolymer and hexafluoropropylene/vinylidene fluoride copolymer.

30. The annealed hydrophilic unsupported porous fluorocarbon membrane of claim 28, wherein said annealing temperature is within the range of about 130° C. to 140° C.

31. The annealed hydrophilic unsupported porous fluorocarbon membrane of claim 28, wherein said non-porous surface is composed of one of glass and Mylar.

32. The annealed hydrophilic unsupported porous fluorocarbon membrane of claim 28, wherein depositing said casting solution includes coating a portion of said non-porous surface with said casting solution using a knife coating process.

33. The annealed hydrophilic unsupported porous fluorocarbon membrane of claim 28, wherein said annealing temperature is selected to maximize a tensile strength of the annealed membrane.

34. The annealed hydrophilic unsupported porous fluorocarbon membrane of claim 28, wherein said solvent is acetone.

35. The annealed hydrophilic unsupported porous fluorocarbon membrane of claim 28, wherein said non-solvent is one of water and alcohol.

36. The hydrophilic unsupported porous fluorocarbon membrane of claim 28, wherein said casting solution includes, by weight, 9.5 to 12.5% of said fluorocarbon copolymer, 25 to 27% of said non-solvent and 60-64% of said solvent.

37. The annealed hydrophilic unsupported porous fluorocarbon membrane of claim 28, wherein the UV/acrylic process includes:
applying a monomer solution to said annealed unsupported membrane; and
applying energy to said annealed unsupported membrane to initiate the creation of free radicals in said annealed unsupported membrane.

38. The annealed hydrophilic unsupported porous fluorocarbon membrane of claim 28, wherein said monomer solution includes an acrylate monomer.

39. The annealed hydrophilic unsupported porous fluorocarbon membrane of claim 37, wherein applying energy to said annealed unsupported membrane includes irradiating said annealed unsupported membrane with ultraviolet light.

40. The annealed hydrophilic unsupported porous fluorocarbon membrane of claim 39, wherein an irradiated surface of said annealed unsupported membrane not in contact with oxygen when said annealed unsupported membrane is irradiated with ultraviolet light.

41. The annealed hydrophilic unsupported porous fluorocarbon membrane of claim 40, wherein said irradiated surface is placed in contact with an airtight film capable of transmitting said ultraviolet light.

42. The annealed hydrophilic unsupported porous fluorocarbon membrane of claim 39, wherein irradiating said annealed unsupported membrane includes focusing energy from an ultraviolet energy source onto an irradiated surface of said annealed unsupported membrane.

43. The annealed hydrophilic unsupported porous fluorocarbon membrane of claim 28, wherein the copolymer content in solution is in the amount of 0.01 g/cm³, and having the ratio of viscosity of the copolymer solution in acetone, to acetone equal to 2.0-4.0

44. A method for producing an annealed hydrophilic unsupported porous fluorocarbon membrane, the method comprising:
dissolving a fluorocarbon polymer, including 23-25 tetrafluoroethylene and 75-77 weight percent vinylidene fluoride copolymer, in a heated solvent, mixing the resultant copolymer solution with a precipitating mixture to produce a casting solution, forming said casting solution into a membrane on a non-porous material;
annealing the membrane at an annealing temperature near a polymer glass transition temperature to produce an annealed membrane;
separating the annealed membrane from said non-porous surface to form an annealed unsupported membrane; and
treating the annealed unsupported membrane with an ultra-violet (UV)/acrylic process to form an annealed hydrophilic unsupported porous fluorocarbon membrane.

45. The method of claim 44, comprising using a ketone as a solvent for the tetrafluoroethylene/vinylidene fluoride copolymer.

46. The method of claim 45, comprising using acetone as the ketone in the amount of 60-70 weight percent of said casting solution comprising from 9.0 to 12.5 weight percent of the fluorocarbon polymer, including the tetrafluoroethylene/vinylidene fluoride copolymer or mixture thereof with other fluorocarbon polymers selected from the group consisting of polyvinylidene fluoride, vinylidene fluoride/trifluorochloroethylene copolymer and hexafluoropropylene/vinylidene fluoride copolymer.

47. The method of claim 44, comprising using a mixture of alcohol and deionized water as a precipitating mixture.

48. The method of claim 44, wherein the alcohol is propyl alcohol or isopropyl alcohol in the amount of at least 14.0 weight percent of said casting solution containing at least 5.0 weight percent of deionized water.

49. The method of claim 44, comprising effecting dissolving of tetrafluoroethylene/vinylidene fluoride copolymer at the temperatures ranging from 30° C. to 50 ° C.

50. The method of claim 44, comprising, in the course of mixing a copolymer solution with a precipitating mixture maintaining a difference in temperatures thereof at 3° C. max.

51. The method of claim 44, comprising maintaining temperature of the casting solution applied onto said non-porous material within the range of 25° C.-45° C.

52. The method of claim 44, comprising storing by a short-term storage of the non-porous material while applying the casting solution occurs under the conditions of free evaporation of a portion of solvent for partial hardening of the casting solution and consequent drying of the membrane, wherein the storing is effected in at least three successive drying zones wherein temperature, increasing from one zone to another, is maintained.

53. The method of claim 52, comprising performing the short-storage for partial hardening of the casting solution at 18° C.-25° C. for about 0.5-1.0 min.

54. The method of claim 53, comprising maintaining temperatures within the drying zones within the following ranges:
first zone—ranging from 45° C. to 55° C.
second zone—from 55° C. to 65° C.
third zone—from 90° C. to 100° C.
and absolute humidity in each drying zone is maintained at the level of not more than 5.0 g/m³.

55. The method of claim 44, wherein the UV/acrylic process includes:
applying a monomer solution to said annealed unsupported membrane; and
applying energy to said annealed unsupported membrane to initiate the creation of free radicals in said annealed unsupported membrane.

56. The method of claim 55, wherein said monomer solution includes an acrylate monomer.

57. The method of claim 55, wherein applying energy to said annealed unsupported membrane includes irradiating said annealed unsupported membrane with ultraviolet light.

58. The method of claim 55, wherein an irradiated surface of said annealed unsupported membrane is not in contact with oxygen when said annealed unsupported membrane is irradiated with ultraviolet light.

59. The method of claim 55, wherein said irradiated surface is placed in contact with an airtight film capable of transmitting said ultraviolet light.

60. The method of claim 55, wherein irradiating said annealed unsupported membrane includes focusing energy from an ultraviolet energy source onto an irradiated surface of said annealed unsupported membrane.

61. The method of claim 44, wherein the copolymer content in solution is in the amount of 0.01 g/cm³, and having the ratio of viscosity of the copolymer solution in acetone, to acetone equal to 2.0-4.0.

62. A cartridge filter comprising:
a protective guard;
a perforated hollow core;
a pair of end caps; and
a pleated annealed hydrophilic unsupported porous fluorocarbon membrane placed between said protective guard and said perforated hollow core and in contact with said end caps.

63. The cartridge filter of claim 62, wherein the pleated annealed hydrophilic unsupported porous fluorocarbon membrane is in contact with a support layer and a drainage layer.

64. The cartridge filter of claim 63, wherein said filter includes two pleated annealed hydrophilic unsupported porous fluorocarbon membranes superimposed so that a pleated annealed hydrophilic unsupported porous fluorocarbon membrane closer to the support layer has a pore size ranging from 0.2 to 0.8 microns and a second pleated annealed hydrophilic unsupported porous fluorocarbon membrane has a pore size ranging from 0.04-0.45 microns.

65. The cartridge filter of claim 63, wherein said filter includes two pleated annealed hydrophilic unsupported porous fluorocarbon membranes superimposed such that active surfaces of said pleated annealed hydrophilic unsupported porous fluorocarbon membranes are directed towards the support layer.

66. A cartridge filter comprising:
an inlet;
an outlet;
a housing; and
at least one annealed hydrophilic unsupported porous fluorocarbon membrane.

67. The cartridge filter of claim 66, wherein said filter includes at least one annealed hydrophilic unsupported porous fluorocarbon membrane formed as a flat sheet.

68. The cartridge filter of claim 66, wherein said filter includes at least one annealed hydrophilic unsupported porous fluorocarbon membrane formed as a flat disc.

69. The cartridge filter of claim 68, wherein flat discs are laminated together to form a disk module.

70. The cartridge filter of claim 68, wherein the disc module includes two annealed hydrophilic unsupported porous fluorocarbon membrane discs with a drainage layer in between.

71. The cartridge filter of claim 70, wherein disk modules are stacked one on top of another and contained in a guard.
